(19) United States
(12) Patent Application Publication
(10) Pub. No.: US 2025/0028481 A1
(43) Pub. Date: Jan. 23, 2025

(54) USING INTERNAL OPERATION FILES HAVING KNOWN PATTERNS ACROSS MULTIPLE DEVICES

(71) Applicant: Western Digital Technologies, Inc., San Jose, CA (US)

(72) Inventors: Eran MOSHE, Kfar Saba, IL (US); Gadi VISHNE, Petach-Tikva (IL); Avichay Haim HODES, Kfar Ben-Nun (IL)

(73) Assignee: Western Digital Technologies, Inc., San Jose, CA (US)

(21) Appl. No.: 18/354,174

(22) Filed: Jul. 18, 2023

(51) Int. Cl. G06F 3/06

(52) U.S. Cl. CPC G06F 3/0659; G06F 3/0619; G06F 3/0679

(57) ABSTRACT

Instead of using external tools for admin control operations for a device, files are used to control the device. As admin controls need to be changed, a special file is generated in the device using a file pattern generator. When the special file is written to the storage device, a file pattern engine recognizes the special file created to extract the vendor specific command. When the special file is written to the storage device, the device will recognize the special file and will perform the operation indicated in the special file. The user is able to use the special file for a single use or future use when needed. In future use cases, the special file is able to be recognized by other devices in need of the special file to execute the vendor specific command.

### BACKGROUND OF THE DISCLOSURE

### Field of the Disclosure

Embodiments of the present disclosure generally relate to improving administration (admin) control through file operation control.

### Description of the Related Art

To perform admin controls in storage devices, external tools used. With the usage of external tools by outside developers, sometimes the usage requires more expert knowledge than with normal usage. Some examples of internal operations include, but are not limited to: device lock, device format (full format or crypto erase), device reset statistics, change of device power consumption by change of power mode, enable/disable write cache, add or remove internal storage processing step for acceleration (strong/weak error correction code protection), enable or disable storage device feature such as host memory buffer (HMB) support, flush cache, and using a dashboard configured to upgrade firmware (FW) to read smart counters. If the device wants to execute these complicated internal operations then some expertise is needed.

When executing these operations there may be times when the use has to move between several applications and settings to complete the operations. Furthermore, when a user is asked to move to a setting, there may be an instance of having to change a mode needed for operation completion. When selecting these modes, the user is asked for permission to perform operations. For example, for a format change, if the device is in read only mode that needs to be written to, then the user has to open up the device of the device is locked. Once the device is unlocked, then the user has to authenticate and then the change can be made.

The issue with the current approach to changing admin controls is the lengthy operations need to change simple settings or modes. These operations increased usage of the device that may lead to performance degradation.

Therefore, there is a need in the art for improving admin control operations through files with operation instructions.

### SUMMARY OF THE DISCLOSURE

Instead of using external tools for admin control operations for a device, files are used to control the device. As admin controls need to be changed, a special file is generated in the device using a file pattern generator. When the special file is written to the storage device, a file pattern engine recognizes the special file created to extract the vendor specific command. When the special file is written to the storage device, the device will recognize the special file and will perform the operation indicated in the special file. The user is able to use the special file for a single use or future use when needed. In future use cases, the special file is able to be recognized by other devices in need of the special file to execute the vendor specific command.

In one embodiment, a data storage device comprises: a memory device; and a controller coupled to the memory device, wherein the controller is configured to: receive a command from a host device to generate a special file for a specific operation; generate the special file; receive a request from a second data storage device to provide the special file to the second data storage device; and provide the special file to the second data storage device.

In another embodiment, a data storage device comprises: a memory device; and a controller coupled to the memory device, wherein the controller is configured to: receive a command from a host device to perform an operation; detect that the operation is an operation containing a known pattern; request a special file correlating to the known pattern from a second data storage device; validate the special file; and perform the operation.

In another embodiment, a data storage device comprises: means to store data; and a controller coupled to the means to store data, wherein the controller includes: a host interface module comprising a file pattern generator; and a file pattern engine configured to recognize operations containing a known pattern, wherein the controller is configured to: detect that a first command from a host device fits a first known pattern with the file pattern engine; retrieve a first special file from a second data storage device, wherein the first special file contains the first known pattern and a first operation associated with the first command; generate a second special file having a second known pattern different from the first known pattern, wherein the second special file is generated in response to a second command from the host device; and send the second special file to the a third data storage device, wherein the first special file and the second special file may be used multiple times by other data storage devices.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic block diagram illustrating a storage system with a file pattern engine, according to one embodiment.

FIG. 3 is a block diagram illustrating a special file format, according to certain embodiments.

FIG. 4A is a flowchart illustrating a method for file pattern generation, according to certain embodiments.

FIG. 4B is a flowchart illustrating a method for file pattern recognition, according to certain embodiments.

FIG. 5 is a block diagram illustrating a storage system that utilizes a file pattern in storage devices, according to certain embodiments.

FIG. 6 is a flowchart illustrating a method for file pattern generation and file pattern recognition, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Instead of using external tools for admin control operations for a device, files are used to control the device. As admin controls need to be changed, a special file is generated in the device using a file pattern generator. When the special file is written to the storage device, a file pattern engine recognizes the special file created to extract the vendor specific command. When the special file is written to the storage device, the device will recognize the special file and will perform the operation indicated in the special file. The user is able to use the special file for a single use or future use when needed. In future use cases, the special file is able to be recognized by other devices in need of the special file to execute the vendor specific command.

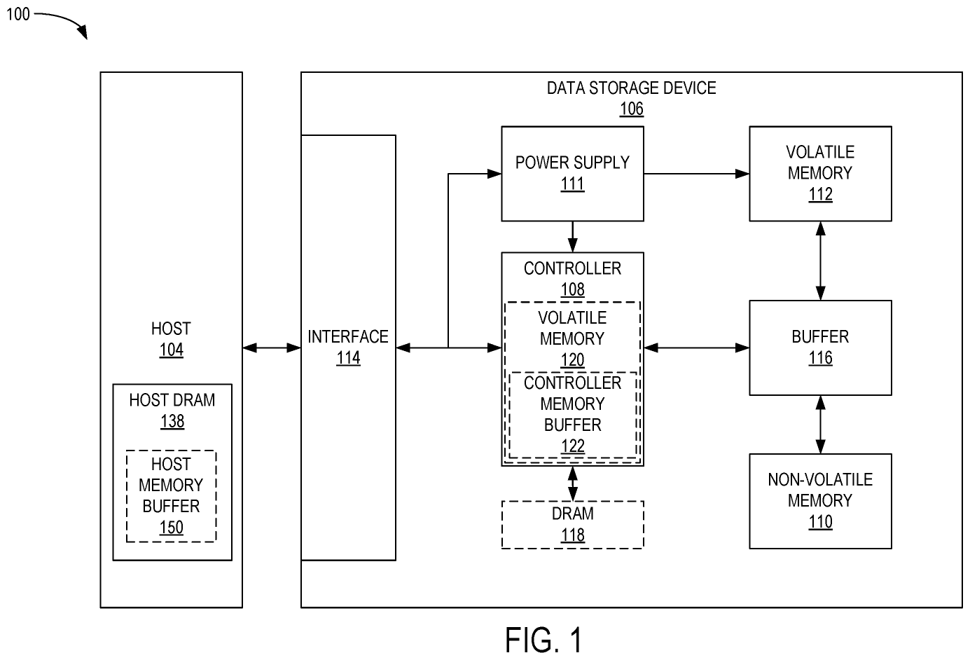

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

As discussed herein, generating files by the data storage device itself is beneficial. The new method involves generating the files by the data storage device using a file pattern generator and extracting the files by a vendor specific command. The user can use the file for future use as several operations or for one time usage. The data storage device itself could recognize the file by an application specific integrated circuit (ASIC) pattern engine. When the file is written to the data storage device, the data storage device will recognize the file and will perform the internal operation instructed by the file.

Examples of internal operations include: device lock, device format such as full format, device format such as crypto erase, device reset statistics, change device power consumption by changing the power mode, enable write cache, disable write cache, add internal storage processing step for acceleration using a strong error correction code (ECC), add internal storage processing step for acceleration using a weak ECC, remove internal storage processing step for acceleration using a strong ECC, remove internal storage processing step for acceleration using a weak ECC, enable storage device feature such as HMB, disable storage device feature such as HMB, and flushing cache.

The idea is to add a pattern to a file and the device itself, during the write command's internal processing, will search for the pattern. When the pattern is found, the device will verify if the file is valid and then will read the operation from the header of the file and perform the internal operation identified in the file.

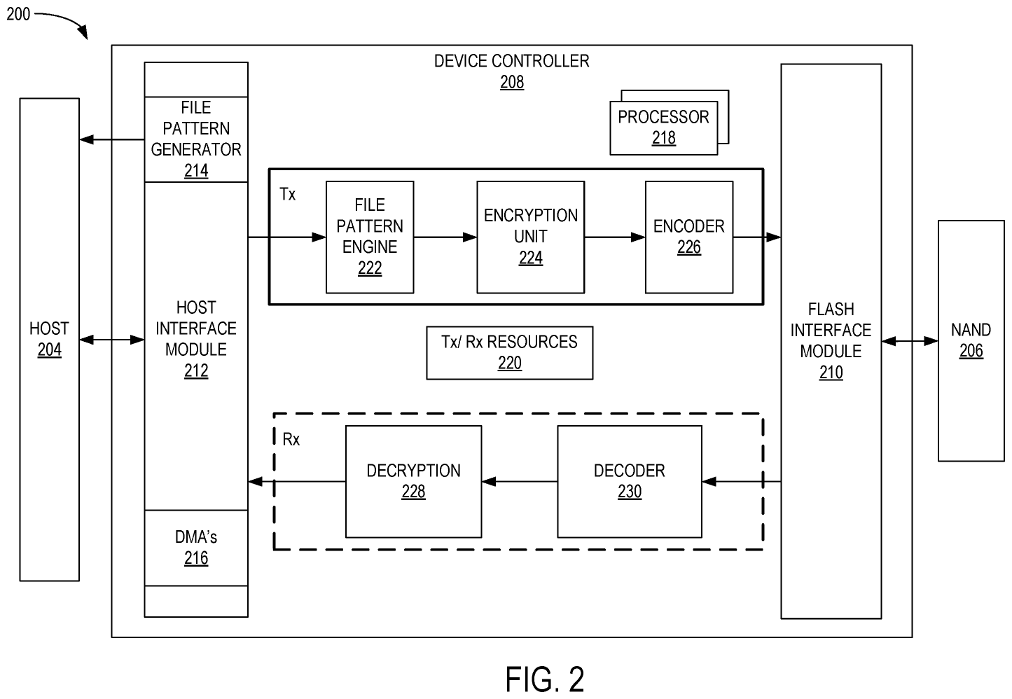

FIG. 2 is a schematic block diagram illustrating a storage system 200 with a file pattern engine, according to one embodiment. The storage system 200 comprises a host 204, a controller 208, and a memory device (e.g. NAND) 206. The host 204 will instruct a file pattern generator 214 to generate a special file for a specific internal operation. For example, the special file can be generated generically or dynamically based on the host 204 requests. Once the special file is generated, the special file will be written to the storage device, such as the data storage device 106 of FIG. 1, through a logical block address (LBA). The special file will be forwarded to a Tx flow (control path) where the file pattern engine 222 will recognize the special file. The specific internal operation will be recognized and executed by the file pattern engine 222. The file pattern engine 222 can either be firmware (FW) or an ASIC.

The controller 208 comprises a host interface module (HIM) 212, a flash interface module (FIM) 210, a plurality of processors 218, the Tx flow, a Rx flow, Tx/Rx resources 220. The HIM 212 further comprises the file pattern generator 214 and direct memory access (DMA) 216. The file pattern generator 214 generates a special file to be used for internal operations. The Tx flow comprises the file pattern engine 222, an encryption unit 224, and an encoder 226. The Rx flow (data path) comprises a decryption unit 228 and a decoder 230. The file pattern engine 222 recognizes the special file generated by the file pattern generator 214.

As an example of operation, the host 204 instructs the data storage device controller 208 to generate a file for a specific operation using the file pattern generator 214. The specific operation can be any operation such as formatting. The controller by way of the file pattern generator 214 creates the special file for the operation. The file is written to the data storage device LBA in the Tx path. During future operations, the file pattern engine 222 will recognize the special file and retrieve the special file to perform the operation.

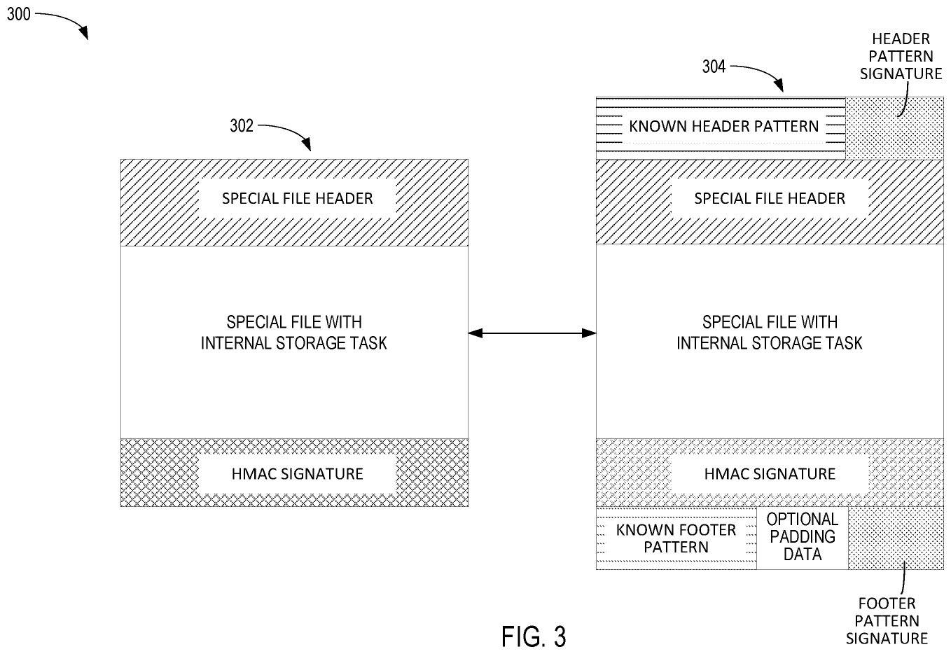

FIG. 3 is a block diagram illustrating a special file format 300, according to certain embodiments. The special file format 300 comprises a special file 302 which will later be considered special file 304 once the special file is assigned. The special file 302 and special file 304 are both generated by the file pattern generator 214 of FIG. 2. When the file pattern engine, such as the file pattern engine 222 of FIG. 2, recognizes a pattern in the content, a special file header will be read. The special file header helps to understand which internal operation is requested by the host such as host 204 of FIG. 2.

The special file 302 comprises a special file header, a special file with internal storage task, and a hash-based message authentication code (HMAC) signature. The special file with internal storage task is in between the special file header and the HMAC signature. The HMAC signature is to insure that the special file has integrity for file verification.

Once the special file 302 is assigned, then the special file 304 is the result. The special file 304 comprises a special file header, a special file with internal storage task, and a HMAC signature. The special file with internal storage task is in between the special file header and the HMAC signature. The special file 304 further comprises a known header pattern with a header pattern signature above the special file header. The special file 304 further comprises a known footer pattern with a footer pattern signature below the HMAC signature. There may be optional padding data between the HMAC signature and the known footer pattern to align to 4K flash memory buffer (FMU). The special file is the content between the known header pattern and the known footer pattern. The special file 304 can be enabled to control of a device, such as storage device 106 of FIG. 1, by authentication. The special file 304 can be disabled to prevent distributed denial-of-service (DDOS) attacks. The special file 304 can include some pattern for format so the device will be filled with the required pattern for example for each byte 0x55 the format pattern can be stored inside the special file after the header.

The device will follow up write commands with FMU in 4 KB resolution in the Tx Flow of FIG. 2. When the pattern is recognized by the file pattern generator 222, the special file header will be read to understand which internal operation is being requested by the host 204.

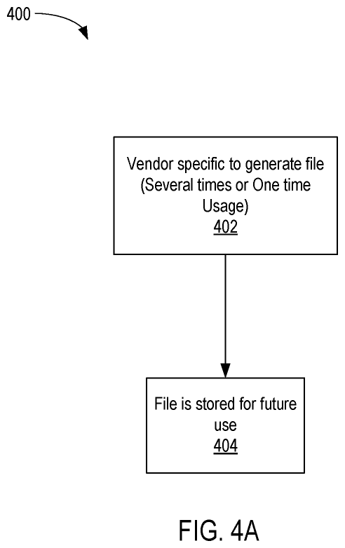

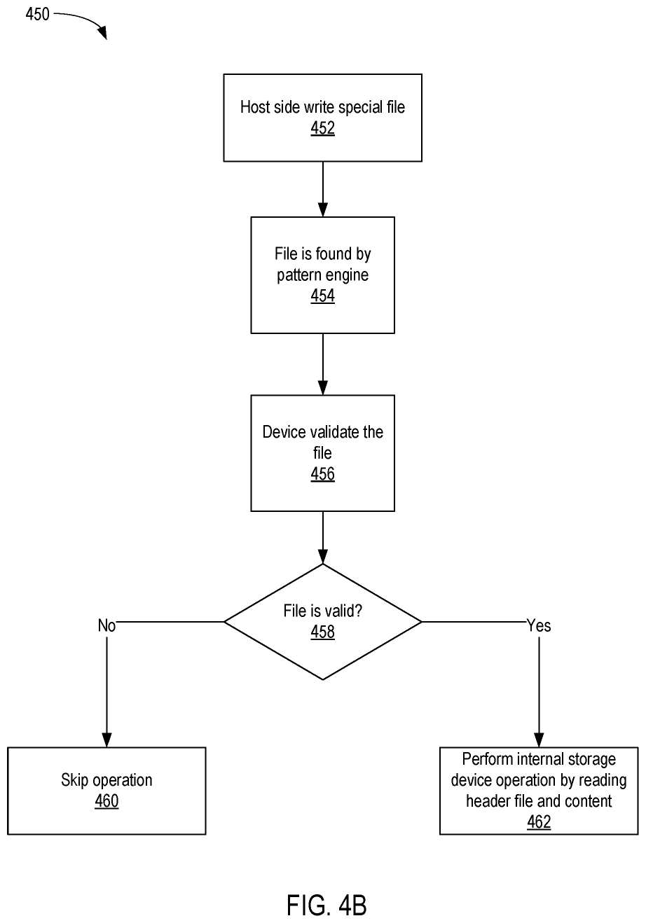

FIG. 4A is a flowchart illustrating a method 400 for file pattern generation, according to certain embodiments. The method 400 begins at block 402. At block 402, the controller, such as the controller 208 of FIG. 2, generates a vendor specific file (special file) for either one time use or a plurality of uses. The file generation at block 402 is executed by the file pattern generator 214 of FIG. 2. At block 404, the vendor specific file is stored for future use. When the vendor specific file is stored, the vendor specific file is stored in a location outside the device. For example, the outside location can be, but not limited to the NAND 206 of FIG. 2.

FIG. 4B is a flowchart illustrating a method 450 for file pattern recognition, according to certain embodiments. Known patterns can be protected by signatures, such as the HMAC signature of FIG. 3, which can help to validate a pattern. The pattern can be found by the file pattern engine 222 of FIG. 2. The special file's content can be in an encrypted format or a clear format. The pattern can include file operation identification (ID) for simple way to understand the internal operation by reading the special file.

The method 450 begins at block 452. At block 452, a device recognizes that a host, such a 204 of FIG. 2, writes a special file for an internal operation. At block 454, the file pattern engine 222 finds the special file. At block 456, the device validates the special file. At block 458, the device determines if the special file is valid. If the device determines that the special file is not valid, then the method 450 proceeds to block 460 to skip the internal operation. If the device determines that the special file is valid, then the method 450 proceeds to block 462. At block 462, the device performs the internal storage device operation by reading header file and content, such as shown in FIG. 3.

The special file recognition feature can be enabled or disabled by a set feature NVMe command on the host side. Method 450 is dynamically operating when the device has remote access allowing the host 204 to decide to enable or disable recognition of a pattern. For example, the host 204 can decide to enable or disable the HMB or cache mode.

The host 204 can request to enable a special file recognition feature, so that the feature is not enabled by default. The feature will depend on use cases or time of operations. For example, if an operation is valid for a long time, then that will be acceptable based on the set time length by the host 204. For cases where the user uses flash cache, the user uses the special file several times. If the user writes the device format file, then damage can be caused to the device. The user should enable the feature of file recognition to prevent the security attacks.

In another example, if there is a remote server and a user (user 1) needs to lock a device remotely, but the user 1 doesn't have access to the device, the special file may be the answer. Even if the server does not have admin control or admin permission to work the device, the device can still be locked. User 2 with permission can create a special file and give the special file to user 1 for one time use to lock the device remotely. User 2 can copy the special file to a shared folder that will then be locked after the special file is run by user 1.

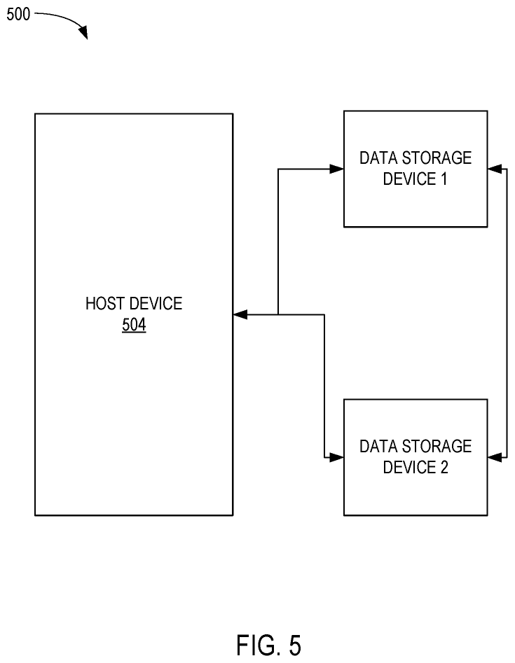

FIG. 5 is a block diagram illustrating a storage system 500 that utilizes a file pattern in storage devices, according to certain embodiments. The storage system 500 comprises a host device 504, a data storage device 1 (device 1), and a data storage device 2 (device 2). Either device 1 or device 2 can be used for method 400 and method 450. In one embodiment, when device 1 utilizes methods 400 and 450, then device 2 will read the special file in device 1 to perform internal operations. In another embodiment, when device 2 utilizes methods 400 and 450, then device 1 will read the special file in device 2 to perform internal operations.

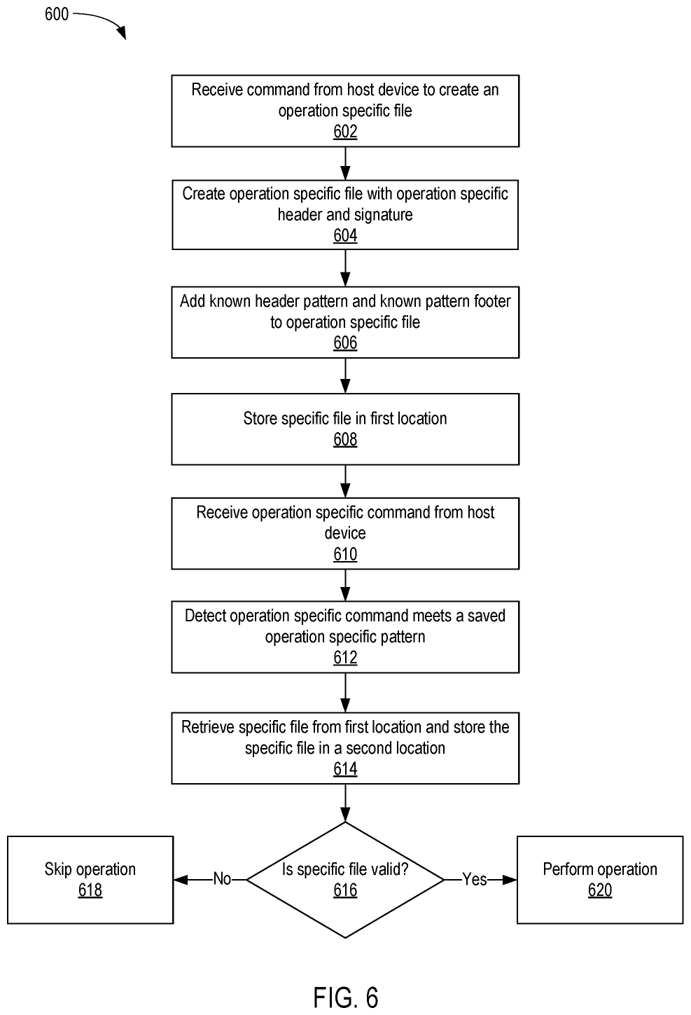

FIG. 6 is a flowchart illustrating a method 600 for file pattern generation and file pattern recognition, according to certain embodiments. The method 600 begins at block 602. At block 602, the controller, such as the controller 108 of FIG. 1, receives a command from a host device to create an operation specific file. At block 604, the file pattern engine creates an operation specific file (special file) with operation specific header and signature. At block 606, a known pattern header and a known pattern footer are added to the operation specific file. At block 608, the controller stores the operation specific file in a first location. At block 610, the controller receives operation specific command from the host device. At block 612, the controller detects an operation specific command meets a saved operation specific pattern. At block 614, the controller retrieves the specific file (special file) from the first location and stores the specific file in a second location. At block 616, the controller determines whether the specific file is valid. If the controller determines that the specific file in not valid, then the method 600 proceeds to block 618 to skip the operation. If the controller determines that the specific file is valid, then the method 600 processed to block 620. At block 620, the controller performs the operation.

The advantages of this new approach to admin control is to perform storage device internal operations by writing files to a device to simplify the storage device configuration. The new approach will help to control several devices by use of special files instead of open external tools. Using special files for admin control will increase performance of the device. The new approach simplifies the storage device configuration and controls admin commands for devices with only input/output (IO) access such as shared folders and cloud based storage.

In one embodiment, a data storage device comprises: a memory device; and a controller coupled to the memory device, wherein the controller is configured to: receive a command from a host device to generate a special file for a specific operation; generate the special file; receive a request from a second data storage device to provide the special file to the second data storage device; and provide the special file to the second data storage device. The special file comprises a special file header, a special file internal operation task, and a signature. The special file comprises a known header pattern and a known footer pattern. The generation occurs in a host interface module (HIM). The controller can be configured to encrypt or sign the special file. The controller is configured to use a hash message authentication code (HMAC) signature to check integrity.

In another embodiment, a data storage device comprises: a memory device; and a controller coupled to the memory device, wherein the controller is configured to: receive a command from a host device to perform an operation; detect that the operation is an operation containing a known pattern; request a special file correlating to the known pattern from a second data storage device; validate the special file; and perform the operation. The operation is selected from the group consisting of: disable HMB support or flush cache. The controller is configured to read the operation from a header of the special file after the validating. The controller is configured to turn on or turn off the detecting. The known pattern includes a file operation identification (ID). The detecting is performed by a file pattern engine. The pattern engine is disposed along a transmission line of the controller.

In another embodiment, a data storage device comprises: means to store data; and a controller coupled to the means to store data, wherein the controller includes: a host interface module comprising a file pattern generator; and a file pattern engine configured to recognize operations containing a known pattern, wherein the controller is configured to: detect that a first command from a host device fits a first known pattern with the file pattern engine; retrieve a first special file from a second data storage device, wherein the first special file contains the first known pattern and a first operation associated with the first command; generate a second special file having a second known pattern different from the first known pattern, wherein the second special file is generated in response to a second command from the host device; and send the second special file to the a third data storage device, wherein the first special file and the second special file may be used multiple times by other data storage devices. The first special file and the second special file each contain a known header pattern and a known footer pattern. The known header pattern and the known footer patter are different for the first special file and the second special file. The controller is configured to encrypt the second special file. The controller is configured to decrypt the first special file. The controller is configured to verify the first special file. The first special file is in volatile memory and the second special file is in nonvolatile memory.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
receive a command from a host device to generate a special file for a specific operation;
generate the special file;
receive a request from a second data storage device to provide the special file to the second data storage device; and
provide the special file to the second data storage device.

2. The data storage device of claim 1, wherein the special file comprises a special file header, a special file internal operation task, and a signature.

3. The data storage device of claim 2, wherein the special file comprises a known header pattern and a known footer pattern.

4. The data storage device of claim 1, wherein the generation occurs in a host interface module (HIM).

5. The data storage device of claim 1, wherein the controller is configured to encrypt or sign the special file.

6. The data storage device of claim 5, wherein the controller is configured to use a hash message authentication code (HMAC) signature to check integrity.

7. A data storage device, comprising:
a memory device; and
a controller coupled to the memory device, wherein the controller is configured to:
receive a command from a host device to perform an operation;
detect that the operation is an operation containing a known pattern;
request a special file correlating to the known pattern from a second data storage device;
validate the special file; and
perform the operation.

8. The data storage device of claim 7, wherein the operation is selected from the group consisting of: device lock, device format, device reset statistics, change power mode, enable write cache, disable write cache, change error correction capabilities, enable host memory buffer (HMB) support, disable HMB support, or flush cache.

9. The data storage device of claim 7, wherein the controller is configured to read the operation from a header of the special file after the validating.

10. The data storage device of claim 7, wherein the controller is configured to turn on or turn off the detecting.

11. The data storage device of claim 7, wherein the known pattern includes a file operation identification (ID).

12. The data storage device of claim 7, wherein the detecting is performed by a file pattern engine.

13. The data storage device of claim 12, wherein the pattern engine is disposed along a transmission line of the controller.

14. A data storage device, comprising:
means to store data; and
a controller coupled to the means to store data, wherein the controller includes:
a host interface module comprising a file pattern generator; and
a file pattern engine configured to recognize operations containing a known pattern, wherein the controller is configured to:
detect that a first command from a host device fits a first known pattern with the file pattern engine;
retrieve a first special file from a second data storage device, wherein the first special file contains the first known pattern and a first operation associated with the first command;
generate a second special file having a second known pattern different from the first known pattern, wherein the second special file is generated in response to a second command from the host device; and
send the second special file to a third data storage device, wherein the first special file and the second special file may be used multiple times by other data storage devices.

15. The data storage device of claim 14, wherein the first special file and the second special file each contain a known header pattern and a known footer pattern.

16. The data storage device of claim 15, wherein the known header pattern and the known footer pattern are different for the first special file and the second special file.

17. The data storage device of claim 14, wherein the controller is configured to encrypt the second special file.

18. The data storage device of claim 14, wherein the controller is configured to decrypt the first special file.

19. The data storage device of claim 14, wherein the controller is configured to verify the first special file.

20. The data storage device of claim 14, wherein the first special file is in volatile memory and wherein the second special file is in nonvolatile memory.
